(19) United States
(12) Patent Application Publication
(10) Pub. No.: US 2005/0066198 A1
(43) Pub. Date: Mar. 24, 2005

(54) Controlling cooperation between objects in a distributed software environment

(76) Inventors: Andrew A. Gelme, Fitzroy (AU); Warren Bloomer, Fitzroy (AU)

Correspondence Address: STITES & HARBISON PLLC, 1199 NORTH FAIRFAX STREET, SUITE 900, ALEXANDRIA, VA, 22314, US

(21) Appl. No.: 10/932,291

(22) Filed: Sep. 2, 2004

Related U.S. Application Data
(60) Provisional application No. 60/499,001, filed on Sep. 2, 2003.

(51) Int. Cl. G06F 15/16; H04L 9/00; H04L 9/32

(52) U.S. Cl. 713/201; 709/201; 719/316

(57) ABSTRACT

The present invention relates to a method of providing authorisation for a cooperation between a first object and a second object in a software environment, the method comprising the steps of: identifying at least one further object that is owned by an owner of the first object, and which has the approval of the owner to engage in the cooperation; identifying the second object; and allowing or denying the cooperation based on whether the second object is one of the at least one further object, thereby providing authorisation for the cooperation.

### CROSS REFERENCE TO RELATED APPLICATION

The present application claims the benefit of U.S. Provisional applications Ser. No. 60/499,001, filed Sep. 2, 2003.

### FIELD OF THE INVENTION

The present invention relates generally to controlling a cooperation between objects in a software environment and has particular, but by no means exclusive, application to providing authorisation of the cooperation.

### BACKGROUND OF THE INVENTION

To ensure that a distributed software environment's integrity is not compromised, it is imperative that the ability of objects to cooperate (interact) with each other is controlled. For example, in some situations it may be necessary to prevent a particular object from accessing another object. To ensure that access is not obtained, the environment should have in place an authorisation process that prevents an attempt by the particular object to gain access to the other object.

### SUMMARY OF THE INVENTION

According to a first aspect of the present invention, there is a method of providing authorisation for a cooperation between a first object and a second object in a software environment, the method comprising the steps of:
identifying at least one further object that is owned by an owner of the first object, and which has the approval of the owner to engage in the cooperation;
identifying the second object; and
allowing or denying the cooperation based on whether the second object is one of the at least one further object, thereby providing authorisation for the cooperation.

It will be appreciated by persons skilled in the art that the word “authorisation” is a term of art that is used to describe the process of allowing or denying an action.

Preferably, the step of identifying the number of objects comprises the step of obtaining a set of one or more identifiers that identify the number of objects.

Preferably, the set of one or more identifiers is one of a plurality of the sets.

Preferably, the step of identifying the second object comprises the step of obtaining an identifier of the second object, and determining whether the identifier is a member of the set.

Preferably, the step of obtaining the identifier comprises using a security token to obtain the identifier.

Preferably, the method comprises the step of authenticating the security token to verify the validity of the identifier.

Preferably, the security token comprises an authentication certification or a shared secret.

Preferably, the authentication certification is used when there is no trust between the first object and the second object.

Preferably, the shared secret is used when there is trust between the first object and the second object.

Preferably, the method comprises the step of determining whether the owner has revoked the security token.

Preferably, the step of determining whether the owner has revoked the security token comprises checking whether the security token is a member of a set of one or more revoked security tokens.

Preferably, the step of allowing or denying the cooperation is also based on the authenticity of the identifier.

Preferably, the step of allowing or denying the cooperation is further based on whether the security token is contained in the set of one or more revoked security tokens.

Preferably, the method further comprises the step of imposing a constraint on the cooperation.

Preferably, the step of imposing the constraint comprises restricting access to a resource.

Preferably, the method further comprises the step of encryption/decryption information exchanged between the first object and the second object.

Preferably, the first object and the second object are each a distributable software object.

Preferably, the cooperation comprises a remote method call.

Preferably, the at least one further object is one of a plurality of further objects.

According to a second aspect of the present invention, there is software that embodies the method according to the first aspect of the present invention.

Preferably, the software comprises a software module arranged to operate as a distributed object.

According to a third aspect of the present invention, there is a device operable to carry out the method according to the first aspect of the present invention.

According to a fourth aspect of the present invention, there is a software development platform operable to create the software according to the third aspect of the present invention.

### BRIEF DESCRIPTION OF THE DRAWINGS

In order that the invention may be more clearly ascertained, a preferred embodiment will now be described, by way of example, with reference to the accompanying drawings, in which:

FIG. 1 is a schematic diagram of a distributed object or Meem according to a preferred embodiment of the present invention;

FIG. 2 is a schematic diagram of the features of a Facet of each of a pair of Meems of the embodiment of FIG. 1;

FIG. 3 is a schematic representation of two Facets (of respective Meems), both of type “Latch”, according to the embodiment of FIG. 1;

FIG. 4 is a schematic representation of the building and activation of a Meem according to the embodiment of the present invention, including the construction of its Facets;

FIG. 5 is a simplified flow diagram of a Meem LifeCycle according to the embodiment of FIG. 1;

FIG. 6 is a schematic diagram of a distributed system according to a second preferred embodiment with two dependent Meems;

FIG. 7 is a flow diagram of Meem Building according to the embodiment of FIG. 6;

FIG. 8 is a flow diagram of a Meem LifeCycle according to the embodiment of FIG. 6, showing both states and transition in that LifeCycle;

FIG. 9 is a flow diagram of Meem Dependency Resolution according to the embodiment of FIG. 6;

FIG. 10 is a flow diagram of a signing procedure used to facilitate control over cooperation between Meems;

FIG. 11 is a flow diagram of a device imprinting procedure used to facilitate control over cooperation between Meems;

FIG. 12 is a flow diagram of a device operating in its own environment;

FIG. 13 is a flow diagram of the procedure which two users follow in order to facilitate control over cooperation between Meems;

FIG. 14 is a flow diagram of a device operating in an environment outside of its own.

FIG. 15 is a flow diagram of the steps taken for introducing redundancy into a process of controlling cooperation between Meems;

FIG. 16 is a flow diagram of the steps taken when a device is lost.

### DETAILED DESCRIPTION

The following description of a preferred embodiment of the present invention is in the context of a distributed software technology that is the subject of patent applications AU 2003204108 and U.S. Ser. No. 10/434,463. It is noted that the present invention is not limited to the distributed software technology, and may be readily incorporated into other distributed software technologies.

The following provides an explanation of the various terms that are used in describing the distributed software technology:
Meem: a distributed object within the distributed system;
MeemPlex: a compound distributed object comprising a plurality of Meems bound together to be strongly encapsulated and self-contained and therefore appear as a single Meem;
Category: a means of grouping a number of Meems;
Dependency: the relationship between each pair of Meems;
Facet: a software component in the form of an interface defining the operation of a Meem, where each Meem can have a plurality of such Facets;
Feature: a system defined function used by all Meems;
HyperSpace: a virtual space that maintains a collection of Categories;
Jini™: a services based distributed system framework;
Jini™ Lookup Service (JLS): a means of locating a
Jini™ Service;
LifeCycleManager (LCM): a distributed object that maintains a collection of Meems;
MeemBuilder: a component that constructs a Meem from its definition;
MeemPath: uniquely identifies a Meem;
MeemRegistry: means for locating Meems;
MeemStore: storage for Meem Definitions and Content;
Reference: Unidirectional connection between Meems;
Virtual Machine (VM): Execution enviroment for the distributed system; and
Wedge: a discrete software component that implements part of a Meem's functionality.

The distributed software technology provides, amongst other things, a platform that prescribes a particular way of using—in one embodiment—the Java/RMI (Java Remote Method Invocation)/Jini™ platforms to form both interfaces (referred to above as a “Facet”) and software object/interface combinations (referred to above as “Meems”).

The platform allows different types of software modules to be provided with suitable Facets and thereby be formed into distributed objects (i.e. Meems) so that diverse devices that are controlled by means of those distributed objects can, despite their differences, communicate electronically with each other and so interoperate in a cohesive and consistent manner.

Examples of devices with software modules in the form of controller software that may includes distributed objects of this type are:
Electrical devices (switches, motors);
Security Devices (proximity card readers, biometric authentication, sensors, cameras);
Electronic multimedia devices (CD/DVD players, television tuners and screens, satellite television tuners);
Data (particularly represented in XML); and
Home automation systems

As will be discussed shortly, the preferred embodiment of the present invention augments the platform with a security mechanism that enables the above mentioned interoperability to occur without compromising system integrity.

Meems

The platform provides tools for putting many of the requirements of distributed software systems into standard interfaces (Facets); such a Facet or Facets, in combination with a software module or modules, constitutes a new distributed software object or Meem. This approach ensures that the framework is flexible and extendable, and that the distributed objects have interfaces that are consistent and interoperable, whilst removing the need to repeat coding tasks.

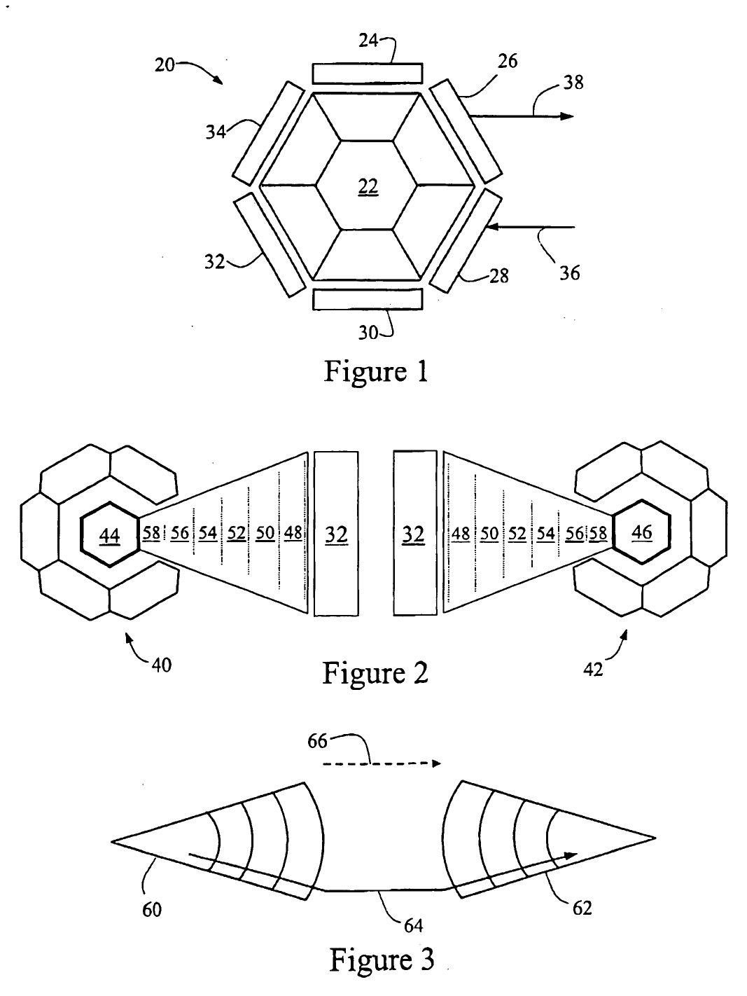

The software modules can be highly individual but the Meems interact in a certain and predictable way. Each Meem has a minimum set of Facets, and each Facet a minimum set of common software development solutions (referred to as “Features”), which ensure that the Meems operate consistently in a distributed environment. A Meem 20 is shown schematically in FIG. 1, and comprises a software module in the form of a software implementation (or ‘IMPL’) 22 and six Facets (each of which deals with an area of distributed software development): Persistence Facet 24, Events Facet 26, State Facet 28, Configuration Facet 30, Location Facet 32 and Lifecycle Facet 34.

Meems thus interact with common interfaces and always have common minimum solutions for distributed software requirements.

Every Meem has an IMPL, which—as it provides the fundamental functionality of the Meem—is the core identity of the respective Meem and defines what the Meem is and what it can do. The IMPL is defined by the software developer.

The Features of each Facet are provided by the platform, but can be extended by the software developer. The Location Facet 32, for example, is provided with the Features Leasing, Threading, Logging, Usability, Transaction and Security. These Features are depicted schematically in FIG. 2, in which two Meems 40, 42 (corresponding respectively to the controlling software of a media player and an MP3 player) include respective IMPLs 44, 46. The Meems 40, 42 each have the Facets listed above; the Location Facet 32 in each case is shown expanded and includes the Features: Leasing 48, Threading 50, Logging 52, Usability 54, Transaction 56 and Security 58, the latter of which is the subject of the preferred embodiment of the present invention.

Thus, the platform—by means of the Meem approach—constitutes a modular solution, where application developers work at a higher level of abstraction. The Facets of a Meem collectively provide the interface through which method (or function) calls are made, both into and out of the Meem. Referring to FIG. 1, the Facets thus intercept all in-bound and out-bound method calls 36, 38 and ensure that a set of operations (the Features) are consistently applied to those method calls.

Facets

Each Facet is a Java™ interface type, with a corresponding part of the IMPL that provides the behaviour (functionality) for that Facet. The same Java™ interface may be used for different Facets, because different behaviour may be associated with different Facets of the same interface type. Facets can be named in order to distinguish between Facets within the same Meem with identical Java interface; such Facets also use different names to indicate different behaviour. Facets are declared as providing either in-bound or out-bound method calls to the Meem.

Meems can refer to other Meems by declaring Dependencies between similarly typed Facets of the two Meems. In this fashion, the out-bound Facet of one Meem can be connected to (i.e. depend upon) the in-bound Facet of another Meem. Similarly, information can flow in the opposite direction: the in-bound Facet of one Meem can depend upon the out-bound Facet of another Meem.

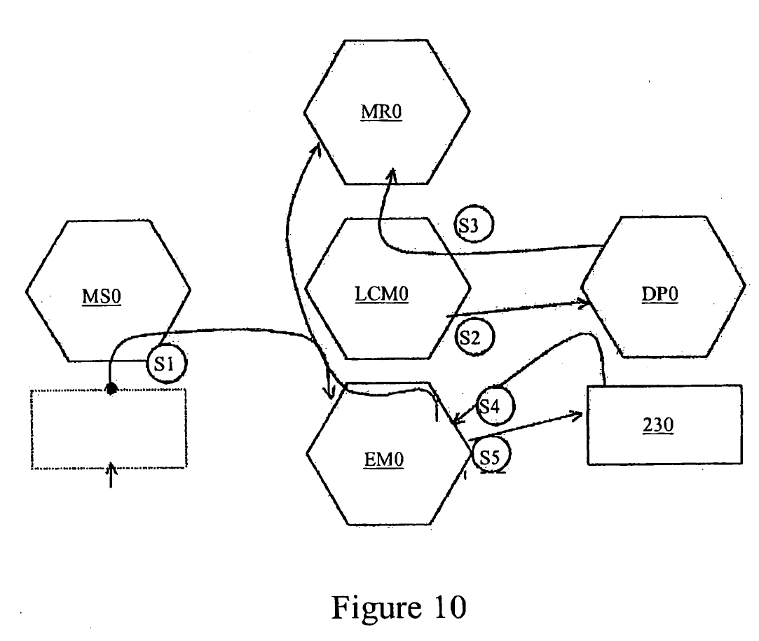

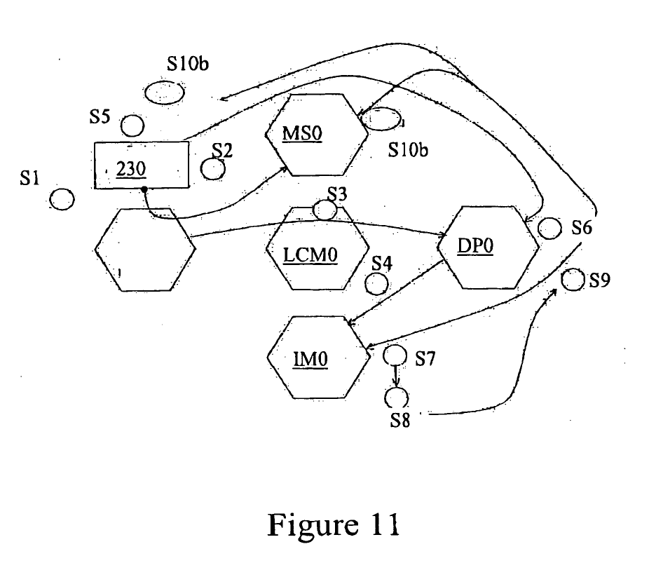

Thus, FIG. 3 is a schematic representation of two Facets 60, 62 (of respective Meems), both of type “Latch”. First Facet 60 has the name “switch” and second Facet 62 the name “light”. The direction of a method call 64 is “out” from first Facet 60 and “in” to second Facet 62. The Dependency 66 is thus from first Facet 60 to second Facet 62. (A more detailed example of Meems of this type is described below by reference to FIGS. 10 and 11.)

Meems, through the use of Facets, extend the utility of, in this embodiment, the Java™ language in three ways:
There is a well-defined way for a Meem to have multiple interfaces of the same type and for external parties to distinguish between them;
The Facets (viz. interfaces) of a Meem can be out-bound, not just in-bound method calls; and
There is a well-defined means for specifying the relationship (Dependencies) between Meems, which is both dynamic and distributed.

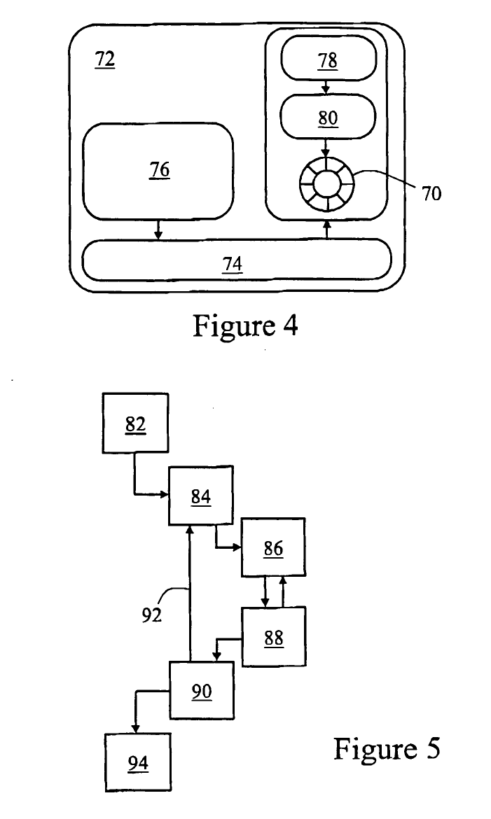

Referring to FIG. 4, according to the system of this embodiment a Meem 70 is activated (such as by being loaded into a Java™ Virtual Machine) by a LifeCycleManager 72, a MeemBuilder 74 uses a MeemDefinition 76 to construct all the Facets and their implementations, and the Meem 70 is built on-the-fly. The Java™ Dynamic Proxy Object is used, so that a single reference 78 is provided to the client of the Meem. Through this reference 78, all of the Facets are accessible via a mapping performed by the Java™ Dynamic Proxy Object 80.

The platform defines a collection of system Facets and Features that are used to build every Meem. These system Facets and Features provide default implementations of the behaviour that the platform expects that all Meems will provide. If necessary, a developer can provide a different implementation of a system Facet, on a per Meem, per MeemPlex (i.e. a complex of Meems, discussed below) or system-wide basis. This allows a system designer to model (preferably using visual tools) his or her application around Meems and design application specific Facets and the relationships (viz. Dependencies) between those Facets. The application developer provides implementations of the required application specific Facets. At runtime, application specific Facets are combined with the system provided Facets to build Meems that function as complete distributed objects.

For a given application domain, application specific Facets can be designed that are then declared to be part of every application specific Meem. For example, for multimedia applications, all multimedia Meems might include a MediaStream Facet.

Thus, a key distinguishing feature of the platform is that a component built by means of the platform (i.e. a Meem) actually provides all the behaviour required of a complete distributed component, through the use of system provided Facets and Features. This allows the system to be extended in a highly modular fashion.

The following list summarises the behaviour embodied by the system provided Facets:

1. Lifecycle

Meems have a well-defined life-cycle that defines the various states through which a Meem may transition. The basic elements of the life-cycle of a Meem is illustrated schematically in FIG. 5. This life-cycle are discussed in greater below (by reference to FIG. 8), as are Dependencies.

Initially, a Meem is created 82 by constructing a MeemDefinition and some initial MeemContent. A Meem that is created, but not yet activated, will be persisted without an instance of the Meem existing in any Java™ Virtual Machines.

Activating 84 a Meem involves using a LifeCycleManager to build an instance of the Meem and attempt to make it “ready” (usually by resolving any required Dependencies). A LifeCycleManager may simply activate all the Meems for which it is responsible, or it may only activate a Meem as required.

Once the Meem's required Dependencies are resolved and its specific resources are acquired, the Meem moves to the ready state 86. The LifeCycleManager registers any Meems that are ready with a MeemRegistry, so that clients can locate the Meem.

Whenever the Meem's required Dependencies are not all resolved or some specific resources are lost, then the Meem becomes “not ready” 88. The LifeCycleManager removes the Meem from the MeemRegistry and it ceases to be available for use. If a Meem has an unrecoverable error, then it moves from the ready to the deactivated state 90 and must be re-activated 92 before it can become ready again.

Alternatively, the LifeCycleManager can decide that a Meem is no longer needed and can deactivate it 90. This means that there is no longer an instance of the Meem running within a Java™ Virtual Machine.

Finally, a Meem can be destroyed 94, which means that it no longer exists within the system.

The LifeCycleManager needs to interact with a Meem, so that it can inform the Meem of state changes that it needs to enforce. Conversely, the Meem must inform the LifeCycleManager of any state changes that are initiated from within the Meem. These interactions are performed via the LifeCycle and LifeCycleClient Facets.

2. Usability

A normally functioning Meem may move smoothly between being activated, ready, not ready, deactivated, activated, and so on. However, when it encounters an unrecoverable error, in order to ensure liveliness of the application state all clients should be informed. This task is performed by the Usability Facet.

3. Configuration

Meem attributes can be either loaded from persistent storage or asynchronously received from other Meems as properties. The Configuration Facet uses those properties and Java™ Reflection to set the attributes in the Meem instance automatically.

4. Persistence

The Meem can be requested, usually by the LifeCycleManager, to persist its attributes. The Persistence Facet provides a default mechanism for performing this function, using Java™ Reflection, and MeemStore for storing the MeemDefinition and MeemContent.

5. Dependencies

The relationship between Meems is defined by Dependencies. Dependencies may be either strong or weak. A strong Dependency is one that must be resolved and bound before the Meem can be made ready. A weak Dependency can be bound or unbound, without affecting the Meem state. However, the Meem must be prepared to handle unbound weak Dependencies.

The Dependency Facet manages the resolution of MeemPaths (using the SearchManager and Spaces), and the location of Meems via the MeemRegistry.

6. Resources

A Meem may have specific resources, such as database connections, that need to be acquired for the Meem to be ready. The application developer may replace the system defined Resource Facet to provide custom code that manages the Meem's resources and informs the LifeCycleManager accordingly.

Features

Between any two Meems in an operational environment, there are common operations that occur on every method call. For example, remote method call semantics may be required (dealing with partial failure) and security access should be checked. The platform provides these common operations as Features.

Features intercept every method call between two Meems. There are a number of different situations, which will be handled using a different sequence of Features: In-bound versus out-bound method calls; Local versus remote method calls; and Calls between MeemPlexes as against within a MeemPlex.

In some cases, the difference is simply one of optimisation. The full sequence of Features could be used, but there is no additional value and a definite performance cost in doing so. For example, there may be no need to check security between two Meems operating within the same MeemPlex. Alternatively, there is no need to use remote method call semantics between two Meems operating within the same Java™ Virtual Machine.

Features are implemented as modular pieces of functionality, and the implementation of each Feature is provided by means of the system provided Facets. However, the key difference between a Facet and a Feature is that the Facets are the visible interconnection points (viz. Dependencies) between Meems, whereas Features are invisibly applied on every in-bound and out-bound method call. The modularity of Features allows flexibility and extensibility so that the Meem environment can cater for different situations as well as provide different or improved functionality in the future.

The following list summarises the behaviour embodied by the system provided Features.

1. Distributed

This Feature provides proxies for handling local and remote method calls. It deals with communication failures with remote Meems and uses Java RMI leasing to ensure liveness between dependent Meems.

2. Thread Decoupling

To avoid design and implementation errors due to threading problems, all interactions between Meems are—by default —thread decoupled. Consequently, method calls to provider Meems return immediately and the operation is continued on another thread. By definition, all Facet method calls need to be designed to operate asynchronously. Information flow in both directions is provided by using Dependencies to refer to a callback Facet.

By default, Meems are assumed to be single threaded and the in-bound method queue is throttled accordingly. Meem developers may declare that their Meem has been designed for multi-threading (reentrant code).

3. Security

All interactions between Meems can be checked for appropriate access privileges. The Security Feature, which will be described in more detail shortly, provides a high-level abstraction for access and denial, which is configurable. It also allows for delegation of authority with constraints, so that one Meem may act on behalf of another Meem. This security is built upon the layers of security already provided by the Java™ language, JSSE™, JAAS™ and Jini™ (Davis) technologies.

4. Flight Recorder

This Feature records in-bound and out-bound method calls, including the Facet type and name, method name, parameters and direction. The Flight Recorder provides a mechanism for the diagnosis of distributed object interaction problems.

5. Transaction

When multiple Meem interactions need to be performed atomically, this Feature looks after the transaction management.

Meem Anatomy

Each Meem Server launches with at least one LifeCycleManager, which defines the lifecycle of a Meem. Facet and Feature factories are then constructed to define the common elements of all Meems that will exist within the lifecycle of the MeemStore.

Stored and discovered Meems are then enabled within the system.

Two or more Meems can be combined to form more complex constructs or “MeemPlexes”. MeemPlexes act in the same way as Meems, in a manner analogous to the way in which complex software objects can be constructed from simpler objects.

A MeemStore can encompass many Java™ Virtual Machines. As long as a Meem ‘exists’ it will survive across Java™ Virtual Machine invocations.

All objects in a MeemStore are themselves Meems, the platform is built with its own technology.

A key concept in this embodiment is a Space (of which a MeemStore is one example). Different types of Spaces are used to store Meems, including both their Definition and Content, as well as various types of relationships between Meems. There are two basic types of Spaces, one that is used for storage and one that is used for relationships between Meems.

A MeemPath is the means by which a Meem is located in one of the available Spaces. There are a number of different circumstances, in which a MeemPath is used. For example, a LifeCycleManager is given a MeemPath which indicates those Meems that it is responsible for activating.

Further, a Dependency between Meems is specified by a MeemPath that is resolved to one or more Meems whose references need to be provided back to the depending Meem. To resolve a MeemPath into one or more Meems, is the job of the SearchManager. The SearchManager knows about the available Spaces and hands the MeemPath to the appropriate Space, expecting a more resolved MeemPath in return. If the SearchManager determines that the MeemPath can be resolved into an individual Meem, then that Meem can be bound using the MeemRegistry.

A MeemPath may refer to a special type of Meem, known as a Category. A Category contains a list of MeemPaths, and is effectively this embodiment's way of defining a group of Meems. All types of Spaces can use Categories to indicate that they are providing a group of Meems, rather than just an individual Meem.

Spaces that maintain Meem relationships can only return MeemPaths thereby, in effect, translating one MeemPath into a set of MeemPaths. Ultimately, a MeemPath needs to refer to a Space that is used for the actual storage of a Meem Definition and its Content. At that point, an unbound Meem can be constructed that can be potentially bound to an activated and ready instance of the Meem running inside of a LifeCycleManager. All available Meems are registered with the MeemRegistry.

Two Spaces that are essential to the operation of this embodiment are:
1. MeemStore: a storage Space that uses the Meem's UUID (Universal Unique Identifier) as a key to locate the Meem's Definition and Content; and
2. HyperSpace: a network of uni-directional links between Meems that can be used to group Meems into various application specific views.
   Meemstore

MeemStore provides the mechanism by which Meems are stored. MeemStore stores both the MeemDefinition and the MeemContent. The MeemStore MeemPath uses the Meem UUID as the key to locating a particular Meem. For example:
MeemStore://ffffffff-ffff-ffff-ffff-ffffffffffff
   MeemStore is a flat (i.e. linear) Space that does not provide any higher level abstraction for organising Meems. However, a Category Meem stored in MeemStore could contain a list of MeemPaths referring to other Meems in MeemStore, allowing simple grouping to occur.
   Hyperspace

HyperSpace provides a directory-like structure for maintaining the relationships between various Meems. HyperSpace is a Category, which acts as a starting point for following MeemPaths throughout the rest of the Space. A HyperSpace MeemPath provides a delimited list of Categories that may be followed to locate a specific point in the HyperSpace. For example:
hyperSpace://site-geekscape/area/backyard/cubbyhouse
   Each name that appears as part of the HyperSpace MeemPath is a Category, except for the final name, which may be either a Category or a non-Category Meem.

HyperSpace does not store any Meem Definition or Content. Category Meems can contain MeemPaths that refer to other Spaces, in particular storage Spaces, such as MeemStore. This means that the same Meem may be referenced in many different Categories. HyperSpace can be used to organise the contents of a MeemStore Space to have different views, depending on the varying application perspectives.

While the above description introduces the fundamental concepts, components and functionality of this embodiment, a more detailed description of a distributed system according to a further embodiment and its most important Features is now provided.

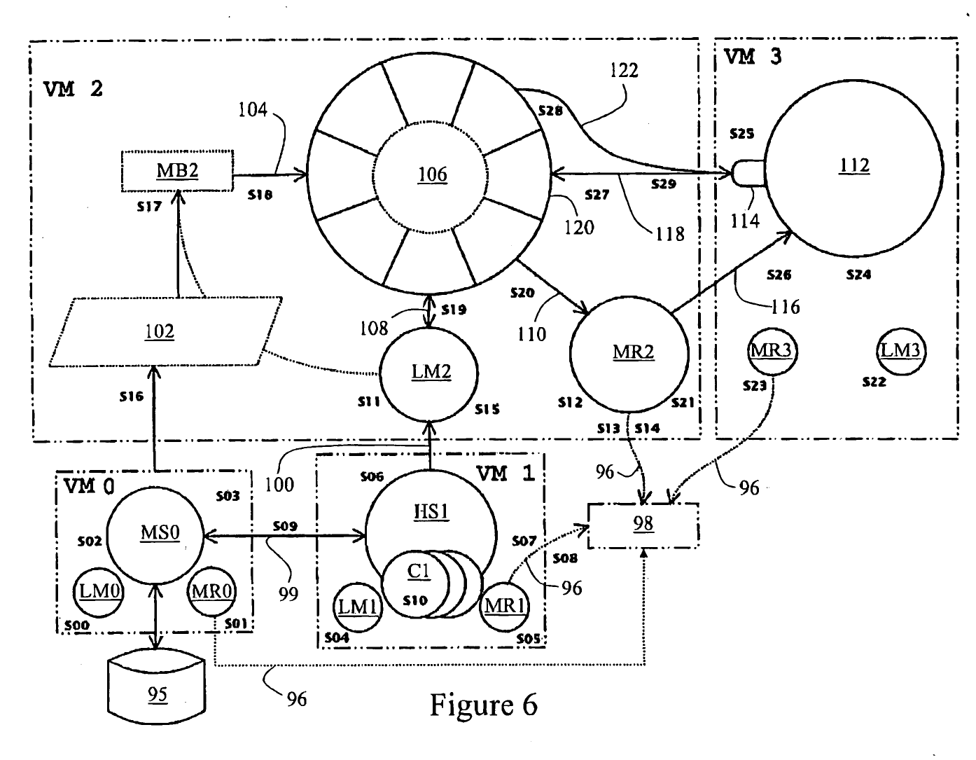

FIG. 6 is a high-level schematic diagram of a distributed system according to the second preferred embodiment with two dependent distributed objects (viz. Meems) during system initialisation and the subsequent creation of the Meems. One Meem depends upon the other and there is information flow in both directions.

The distributed system of this embodiment involves a number of Virtual Machines (VMs), two of which contain system components, such as MeemStore and HyperSpace; each of the other two contains a distributed application object, namely, “Target Meem” and “Client Meem”. The whole system is in communication with persistent data storage 95.

Thus, referring to FIG. 6, the various components are identified, as are the sequential steps involved in system initialisation and Meem creation.

Step S00 involves creating a LifeCycleManager in VM0 (i.e. Virtual Machine 0). All VMs that create and run Meems require a LifeCycleManager (LCM). The LifeCycleManager maintains a collection of Meems, especially paying attention to changes in their LifeCycle state (a process described in greater below). The LifeCycleManager will be registered with the MeemRegistry.

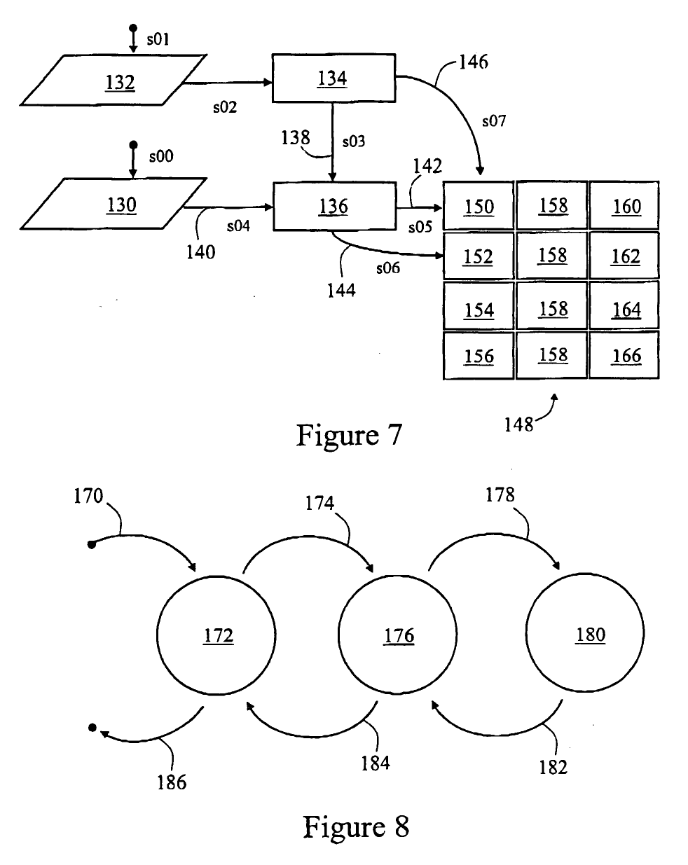

Step S01 involves creating a MeemRegistry MR0 in VM0. All VMs that participate in the system require a MeemRegistry to both register (and export) their Meems, as well as locate other Meems. The MeemRegistry has its LifeCycle maintained by the LifeCycleManager. The creation of a Meem is further described in steps S12 to S20, and in greater detail below by reference to FIG. 7.

In Step S02 a MeemStore MS0 is created in VM0. A MeemStore stores the definition and content of the Meems. Each Meem can be individually located within the MeemStore by its MeemPath. The MeemStore is unstructured, such as linear with no hierarchy. Only a single MeemStore is required. However, multiple MeemStores can operate concurrently and they are effectively consolidated, so as to appear as a single MeemStore. The MeemStore is registered with the MeemRegistry. The MeemStore has its LifeCycle maintained by the LifeCycleManager.

In Step S03, MeemRegistry MR0 in VM0 registers 96 with the Jini™ framework. That is, the MeemRegistry MR0 exports itself as a Jini™ Service to the Jini™ Lookup Service 98 so that Meems can be distributed across multiple VMs. Every Meem has a Scope that determines the extent to which a Meem can be located, such as only within its VM or between VMs on a LAN. (Step S08 describes the process of a Meem being located.)

In Step S04, a LifeCycleManager LCM1 is created (as per Step S00) in VM1.

In Step S05, a MeemRegistry MR1 is created (as per Step S01) in VM 1. To demonstrate a situation in which the system is itself distributed, this embodiment includes MeemStore MR0 and a HyperSpace HS1, which are two vital pieces of infrastructure, operating in different VMs (respectively VM0 and VM1). Like most important parts of the system, MeemStore MS0 and HyperSpace HS1 are themselves Meems, which means that they can be easily distributed on different computer hardware systems.

Thus, in Step S06 HyperSpace HS1 is created in VM1. HyperSpace HS1 stores the relationship between Meems. As mentioned above, a HyperSpace maintains a collection of Categories C1. A Category is a key object structure, and is a mechanism for maintaining a set of Meems that are similar in some fashion. Each Category has a number of entries, each of which is a MeemPath that provides a means for locating the Meem. Since a Category is itself a Meem, a Category may link to other Categories and well as regular Meems. Meems may appear in multiple Categories. HyperSpace and Categories are similar to the World Wide Web and web pages, in that web pages contain unidirectional hyperlinks to other web pages, and so on. HyperSpace is itself a Category (and a Meem), which acts as a starting point for following MeemPaths throughout the Space, by holding entries that refer to other important (top level) Categories. For more details, see step S10.

In Step S07, MeemRegistry MR1 in VM1 registers 96 with the Jini™ framework (as per Step S03).

In Step S08, HyperSpace HS1 in VM1 locates MeemStore MS0 via MeemRegistry MR1. HyperSpace HS1 only maintains the relationships between Meems; it does not provide storage for the Meems. This also applies to the Categories C1 that HyperSpace HS1 maintains. HyperSpace HS1 uses MeemStore MS0 to store the Category definitions and contents. This Step includes a number of substeps:
Substep S08a: HyperSpace H1 asks MeemRegistry MR1 for MeemStore MS0;
Substep S08b: MeemRegistry MR1 determines that MeemStore MS0 is not local;
Substep S08c: MeemRegistry MR1 locates other
MeemRegistries (MR0, MR2, MR3) via the Jini™ framework;
Substep S08d: Other MeemRegistries (MR0, MR2, MR3) are asked for a MeemStore; and
Substep S08e: The MeemRegistry MR0 in VM0 provides a remote Reference to the MeemStore MS0.

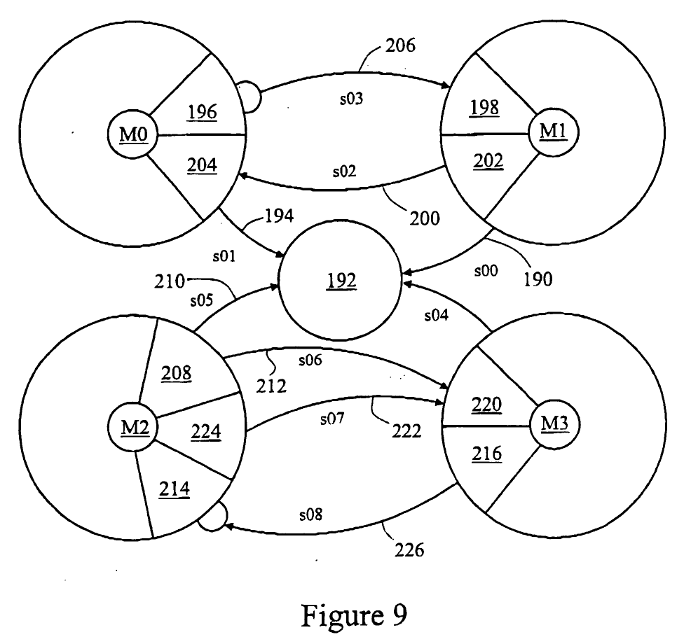

The mechanism for one Meem to refer to another Meem so that method invocations can be made is known as a Dependency. Step S25 describes the Dependency mechanism. This process is also described in greater detail below by reference to FIG. 9.

In Step S09, HyperSpace HS1 restores 99 Categories C1 using MeemStore MS0. Whenever Meems depend upon a Category, HyperSpace HS1 dynamically restores the desired Category by using the definition and contents that have been previously stored in MeemStore MS0.

In Step S10, Categories C1 group similar Meems. Most applications will need to group Meems together. Categories dynamically maintain a list of entries. Whenever an entry is added or removed, all Meems that depend upon that Category are notified.

In Step S11, a LifeCycleManager LCM2 is created (as per Step S00) in VM2.

In Step S12, a MeemRegistry MR2 is created (as per Step S01) in VM2.

In Step S13, MeemRegistry MR2 in VM2 registers 96 with the Jini™ framework (as per Step S03).

In Step S14, LCM2 in VM2 locates HyperSpace HS1 via MeemRegistry MR2. The LifeCycleManager LCM2 depends upon a Category to be used in step S15. To acquire the Category, the LifeCycleManager LCM2 needs a Reference to HyperSpace HS1, which happens to be in VM1. The sequence of “location” operations is similar to Step S08.

In Step S15, LCM2 determines which Meems to manage 100. All LifeCycleManagers depend upon a specified LCM Category (typically in HyperSpace) that contains a list of Meems to be maintained by a LifeCycleManager in a particular VM. The LifeCycleManager uses HyperSpace to acquire a MeemPath to the LCM Category, upon which it depends. As Meems are added or removed from the LCM Category, it dynamically notifies the LifeCycleManager, which either creates or destroys the Meem.

The process of creating a Meem is described in Steps S16 to S21:

In Step S16 the Meem Definition 102 (including Wedge Definition, FacetDefinition and DependencyDefinition) is acquired. The LifeCycleManager LCM2 is responsible for the complete LifeCycle of a Meem, from creation through to destruction (see FIG. 5). It performs this process by coordinating the actions of a number of other processes. For a given Meem, the first step is to use the MeemPath extracted from the Category entry provided in Step S15. This MeemPath is used to locate the MeemDefinition in MeemStore MS0;

In Step S17, the MeemDefinition is given to the MeemBuilder MB2. The LifeCycleManager LCM2 provides a MeemDefinition to the MeemBuilder MB2, which uses that Definition to assemble all the defined pieces into a single, seamless, encapsulated distributed component, the Meem;

In Step S18, the MeemBuilder MB2 constructs 104 the Target Meem 106. All of the Wedges defined by the application for this Meem 106, plus the predefined system Wedges are created. For each Wedge, the various in-bound and out-bound Facets are created. For each Facet, a Dependency on other Meems may be attached. This process is described in greater detail below by reference to FIG. 7;

In Step S19, the LifeCycleManager LCM2 maintains 108 Target Meem 106. The MeemBuilder MB2 returns the newly constructed Meem back to the LifeCycleManager LCM2. The LifeCycleManager LCM2 assigns a MeemPath to the Meem 106, based on the MeemStore MS0 used by the LifeCycleManager LCM2 for Meem storage. This MeemPath can be used by other Meems to uniquely locate this new Meem 106;

In Step S20, the Target Meem 106 registers 110 with MeemRegistry MR2, so that the Target Meem 106 can be located by other Meems. A Weak Reference to the Target Meem 106 is added to the MeemRegistry. Apart from the TargetMeem Reference maintained by the LifeCycleManager LCM2, all other TargetMeem References distributed throughout the system are Weak or Remote References. This means that the Target Meem 106 can be entirely destroyed and completely removed by the LifeCycleManager, regardless of any other References; and

In Step S21, the MeemRegistry MR2 notifies MeemRegistry Clients. The Target Meem 106 is added to the MeemRegistry MR2. Other Meems can depend upon the MeemRegistryClient Facet to receive notifications regarding Meem additions and removals from the MeemRegistry MR2. This mechanism allows one Meem to uniquely locate another Meem by its MeemPath.

In Step S22, a LifeCycleManager LCM3 is created (as per Step S00) in VM3.

In Step S23, a MeemRegistry MR3 is created (as per Step S01) in VM3. The MeemRegistry MR3 registers 96 with the Jini™ framework (as per Step S03). In Step S24, a Client Meem 112 is created (as per Steps S14 to S21) in VM3.

In Step S25, the Client Meem 112 has a Dependency 114 on the Target Meem 106. A Dependency between Meems is resolved into a unidirectional Reference. Either Meem can depend upon the other and establish a flow of information, independent of the direction of the Dependency. Dependencies between Meems can be mutual, as described in steps S26 to S29.

In Step S26, the Client Meem 112 locates 116 the Target Meem 106. The Client Meem 112 depends upon the MeemRegistryClient Facet of the MeemRegistry MR3 in VM3 (created in Step S22). A Filter is used that contains the MeemPath of the Target Meem 106. Since MeemRegistry MR3 does not have a local Reference to the Target Meem 106, MeemRegistry MR3 checks with all the other MeemRegistries (MR0, MR1, MR2) discovered via the Jini™ Lookup Service 98. The MeemRegistry MR2 in VM2 responds with the Target Meem 106 Remote Reference, which is then handed back to the Client Meem, via the MeemRegistry MR3 in VM3.

In Step S27, the Client Meem 112 acquires a Reference 118 to the desired Facet 120. Using the Target Meem 106 Reference acquired in Step S26, the Client Meem 112 requests a Reference to the Target Meem Facet 120 specified in the Dependency. This Target Meem Facet 120 Reference is then used to update the out-bound Facet field in the Client Meem Wedge implementation. This allows the Client Meem 112 to send messages to the Target Meem 106.

In Step S28, the Target Meem 106 resolves a Dependency 122 on the Client Meem 112. In this example, the Client Meem 112 has another Dependency 112 on the Target Meem 106 that defines a Reference from a specific out-bound Target Meem Facet to an in-bound Client Meem Facet. The Client Meem 112 sends this Dependency to the Target Meem 106, which then resolves it into a Reference to the specified Client Meem Facet (in a manner similar to Step S27).

In Step S29, messages are sent between the Client Meem 112 and the Target Meem 106. Now that the Client and Target Meems have References to each other, messages can be asynchronously sent in either direction. If, at any time, either Meem 106, 112 or the network should fail, the References are automatically removed and the Dependencies become unresolved. If either of the Dependencies are “strong”, then the Client Meem 112, which declared the Dependency, will become “not ready” 88 (see FIG. 5). This effect will ripple throughout the system, causing Meems to become dormant, until the problem is resolved.

The following sections describe specific processes of this embodiment in greater detail, including Meem Building, Meem LifeCycle, Meem Dependency Resolution, Asynchronous thread decoupling and the Meem Developer Tool

Meem Building

As discussed above, Meems are the basic building blocks of the distributed system of this (or the first) embodiment and of the applications running as part of that system, while Meems comprise a number of more fundamental parts, known as Wedges, Facets and Dependencies. The MeemDefinition comprises all the Definitions of those fundamental parts. The MeemBuilder can take a MeemDefinition and dynamically create a new instance of a Meem, during the run-time of the system. The MeemDefinition contains an identifier, one or more WedgeDefinitions, a Scope that determines the extent of a Meem's visibility and a version number. A Wedge provides part of the implementation behaviour of a given Meem. The WedgeDefinition contains an identifier, zero or more FacetDefinitions, an implementation class name and a list of fields that describe the persistent state of that Wedge. A Facet is an external interface of the Meem that can either receive in-bound method invocations or deliver out-bound method invocations, but not both. A FacetDefinition contains an identifier, an indicator of whether an in-bound Facet requires initial state and a single DependencyDefinition. A Dependency defines a dynamic relationship with another Meem. The direction of the resulting Reference (flow of information) can be in the same or opposite direction to that of the Dependency. The DependencyDefinition contains a MeemPath to locate the other Meem, a Scope that determines the extent of locating the other Meem and a Dependency type. Even though a given Meem Facet has only a single Dependency, it may depend on multiple other Meems, if the Dependency is on a Category Meem (grouping concept) and the Dependency type is either “strongMany” or “weakMany”. (Dependencies, their types and their resolution are described in greater detail below by reference to FIG. 9.) Once a Meem is constructed, one of the system defined Wedges provides the MetaMeem (in-bound) and MetaMeemClient (out-bound) Facets. These Facets can be used during the system run-time to dynamically add new or remove any of the Definitions that describe parts of the Meem.

This allows Wedges, Facets or Dependencies to be added or removed whenever the Meem is in “active” state 84. Importantly, a distributed object—which can be dynamically created, altered and destroyed—embodies all of the required system and application behaviour as a single, seamless and strongly encapsulated whole.

FIG. 7 is a flow diagram of Meem Building according to this embodiment, and depicts the process by which a Meem is constructed.

In Step 00, a Definition 130 for the system defined Wedges are created. All Meems created by the system will consist of a certain number of Wedges and their Facets, which provide core behaviour required by a distributed component that interacts with other distributed components in a well-defined and consistent manner.

In Step S01, a MeemDefinition 132 for the application defined Meem is created. Applications can define a set of one or more Wedges, their Facets and their Dependencies, which provide a given Meem with its specific personality. This MeemDefinition 132 may be created programmatically, recovered from a storage mechanism or transmitted across a communications protocol.

In Step S02, the MeemDefinition 132 is provided to a LifeCycleManager 134. All Meems are created by the LifeCycleManager 134 that maintains their LifeCycle from creation through to destruction.

In Step S03, the LifeCycleManager 134 uses the MeemBuilder 136 to create 138 the Meem. The actual process of constructing the Meem may be delegated to a specific Meem building mechanism.

In Step S04, the system defined Wedges are provided 140 to the MeemBuilder 136.

In Step S05, the MeemBuilder 136 creates 142 the system defined Meem parts. The MeemBuilder 136 examines the MeemDefinition 132 and the various parts that it contains. For each WedgeDefinition, a Wedge implementation is created. Any references between Wedges for inter-Wedge communication are resolved. For each FacetDefinition, a Facet is created, as well as method invocation Proxies for intercepting all in-bound and out-bound method calls to and from a Wedge implementation. For each DependencyDefinition, a Dependency is created. All of these parts are combined into a single Meem instance that is capable of routing in-bound method calls to the appropriate implementation code and invoking out-bound method calls on a collection of Meems.

In Step S06, the MeemBuilder 136 creates 144 the application defined Meem parts. Application specific Wedges, Facets and Dependencies are added to the Meem in a process similar to Step S05, except that, now that the Meem's system defined Wedges are in place, the MetaMeem Facet can be used to perform all Meem, Wedge, Facet and Dependency Definition altering operations.

In Step S07, the LifeCycleManager 134 assigns a MeemPath 146 to the new completed distributed object, or Meem, 148. The Meem 148 comprises a DependencyHandler 150, a MetaMeem 152, the Reference Handler 154, Application Inbound Facet 156, Wedges 158, Meem Client 160, MetaMeem Client 162, Reference Client 164, and Application Outbound Facet 166.

Meem Lifecycle

As discussed briefly above, Meems have a simple and well defined LifeCycle that marks their passage from creation, through operational states and finally destruction. A special quality of the invention is that changes in the LifeCycle state of a given Meem will also affect the state of other Meems that depend upon that Meem. These Meem Dependency relationship changes occur in a well defined and consistent manner.

Meems have three LifeCycle states and six state transitions:
Created: the Meem exists in a storage mechanism; the Meem cannot be located via MeemRegistry.
Active: the Meem is managed by a LifeCycleManager; the Meem can be located via MeemRegistry; Dependencies upon system Wedges can be resolved; Dependencies upon application Wedges can not be resolved; application specific Definitions can be altered;
Ready: Dependencies upon application Wedges can be resolved; the Meem can be used by other applications Meems; application specific Definitions can not be altered.

FIG. 8 is a flow diagram of a Meem LifeCycle according to this embodiment, including the states and transitions.

Transition 170: Meem Creation. A Meem can only be created once. Meems can only be created by a LifeCycleManager in a running system. A MeemDefinition is used to describe the Meem to be created. As the Meem is created, both its MeemDefinition and MeemContent are persisted in a storage mechanism, such as MeemStore. A Meem that exists, but is not being managed in a VM by a LifeCycleManager is in the “Created” state 172.

Transition 174: Meem Activation. A LifeCycleManager restores the MeemDefinition and MeemContent from a storage mechanism, such as MeemStore. The Meem is built using the MeemDefinition and its MeemContent is written (or placed) back into the Meem. The Meem is registered with the local MeemRegistry. The Meem's system Wedges are made available, but not its application Wedges. Other Meems that depend upon system Facets of this Meem may do so. Once this Transition is completed, the Meem is in the “Active” state 176.

Transition 178: Become Ready. The Meem attempts to resolve any Dependencies upon other Meems. The Meem attempts to acquire any resources required by the application, such as database connections, hardware devices, etc. The Meem can only move to the “Ready” state 180 when all of its Strong Dependencies and application defined resources have been acquired.

Transition 182: Not Ready. A Meem can perform this transition for a number of reasons; any of its Strong Dependencies are lost, any of its application defined resources are lost, the Meem has an internal failure or exception thrown, the Meem itself decides to become “not ready”, another Meem requests the Meem become “not ready”, the LifeCycleManager needs to terminate, or the system is being shut-down. Any other Meems that depended upon the application Facets of this Meem are notified; the Meem is then in the “Active” state 176.

Transition 184: Deactivate. The Meem is deregistered from the local MeemRegistry. The MeemContent is updated in the storage mechanism, such as the relevant MeemStore. The Meem is deconstructed and removed from the VM. It is now in the “Created” state 172.

Transition 186: Destroy. A Meem can only be destroyed once. The MeemDefinition and MeemContent are removed from the storage mechanism, such as the relevant MeemStore. The Meem no longer exists.

Meem Dependency Resolution

A Dependency defines the relationship between Meems. A single Dependency can be associated with each Facet of a Meem. Once a Meem is registered with the MeemRegistry, then the system will attempt to resolve any Dependencies related to that Meem. A Dependency uses a MeemPath to locate a specific Meem, then an identifier to select the correct Facet. The Dependency can only be resolved by matching Facets of the correct interface type and also that out-bound Facets must be connected to in-bound Facets. The Dependency type may be either “strong”, “strongMany”, “weak” or “weakMany”. All Strong Dependencies must be resolved for the application defined Facets of a Meem to be ready for use. Weak Dependencies may be resolved or not, without affecting the Meem's readiness. StrongMany and WeakMany Dependencies mean that if the other Meem being referred to is a Category Meem, then all the Meems contained in that Category will be depended upon.

FIG. 9 is a flow diagram of Meem Dependency Resolution according to this embodiment, that is, the process by which Dependency relationships between Meems are resolved. The resolution of the Dependency between Meem M0 and Meem M1 allows Meem M0 to invoke from its Provider Facet a method defined in the Client Facet of Meem M1. The resolution of the Dependency between Meem M2 and Meem M3 allows Meem M3 to invoke from its Provider Facet a method defined in the Client Facet of Meem M2. This demonstrates that the direction of the Dependency, that is, which Meem defines the Dependency, can be independent of the direction of the Reference that is set-up.

In Step S00, Meem M1 registers 190 with MeemRegistry 192. That is, when Meem M1 moves to the “active” state, its LifeCycleManager registers 190 it with the MeemRegistry 182. As soon as Meem M1 has all its strong Dependencies resolved and all application specific resources are acquired, then the Facets of its application defined Wedges can be depended upon.

In Step S01, Meem M0 acquires 194 Reference to Meem M1. Meem M0's out-bound Provider Facet 196 has a Dependency on Meem M1, which includes both Meem M1's MeemPath and the identifier for the Facet of interest, such as “Client” Facet 198. Using the MeemRegistry 192, Meem M0 can specify the unique MeemPath of Meem M1 and thus acquire a Meem Reference to Meem M1. This Meem Reference provides access to all the system defined Facets of Meem M1.

In Step S02, Meem M0 acquires 200 Reference to Meem M1 Client Facet 198. By using the Meem M1 Reference (from Step S01), Meem M0 can utilize Meem M1's ReferenceHandler Wedge 202. This allows Meem M0 to acquire (by means of its DependencyHandler 204) specific References to any of the application defined Facets of Meem M1. In this case, Meem M0 using the identifier for the Facet of interest (such as Client Facet 198) can acquire a Reference to that Facet.

In Step S03, Meem M0 Provider Facet 196 invokes 206 on Meem M1 Client Facet 198. Using the in-bound Client Facet Reference (from Step S02), Meem M0 can update any object references that refer to that Facet. Assuming this is a strong Dependency, Meem M0 can now be moved to the “ready” state. Any events that cause Meem M0 to utilize its out-bound Provider Facet can now proceed, because the object reference to Meem M1's in-bound Client Facet 198 is now valid.

In Step S04, Meem M3 registers with MeemRegistry 192. This is similar to Step S00 above.

In Step S05, Meem M2—by means of its DependencyHandler 208—acquires 210 Reference to Meem M3. This is similar to step S01 above.

In Step S06, Meem M2—by means of its DependencyHandler 208—delivers Dependency 212 to Meem M3. Since Meem M2's Client Facet 214 is in-bound and Meem M3's Provider Facet 216 is out-bound, this dictates that the “flow of information” 218 is in the opposite direction to that of the Dependency 212. This means that the Meem defining the Dependency, in this case Meem M2, must pass that Dependency information over to Meem M3. This allows Meem M3 to create a Reference in the appropriate direction. Meem M3's system defined DependencyHandler 220 accepts such requests and causes the following Step S07 to occur as a consequence.

In Step S07, Meem M3 acquires Reference 222 to Meem M2 Client Facet 214. Using the Dependency information from step S06, Meem M3 acquires—by means of its ReferenceHandler 224 a Meem M2 Client Facet Reference in a similar fashion to Step S02 above.

In Step S08, Meem M3's Provider Facet 216 invokes 226 Meem M2 Client Facet 214. This is similar to Step S03 above.

Asynchronous Thread Decoupling

One of the standard Features provided in these embodiments is the automatic decoupling of a thread of control for method invocations between two Meems. This means that all method invocations between an out-bound Facet of a Provider Meem and the in-bound Facet of a Client Meem, are queued. This allows the thread of control that was operating in the provider Meem to continue without blocking. As required, a ThreadManager will schedule a separate thread to undertake the task of executing the method invoked on the Client Meem. The most important benefit of this approach, is that the thread of control executing in a Meem can never be blocked by the operation of another Meem.

Typically, a well-designed application system is modularized in terms of its functionality. However, also typical, is that method invocations between components in an application system will continue to call each other on the same thread. This means that complex and often unpredictable interactions may occur between components, especially when Object Oriented listener-based design patterns are employed.

By decoupling the thread of control from invocations between Meems, this invention enforces modularization in the time domain. Each in-bound method invocation can be considered purely in the context of the Meem's current state. Situations in which a thread of control leaves a Meem via an out-bound Facet and then returns via a call-back on another in-bound Facet do not need to be considered. This reduces the complexity of designing a distributed application.

Security

As mentioned previously, the preferred embodiment of the present invention focuses on the security Feature of a Meem. The following provides definitions for the terminology used in describing the security Feature:
Subject: A subject represents a grouping of related information for a single entity, such as a person or a Meem. Such information includes the Subject's identities as well as its security related attributes (passwords and cryptographic keys, for example).
Principal: the multiple identities a subject may have are represented as Principals with the subject. Principals simply bind names to a subject.
Credentials: The security related attributes that a subject may own are referred to as credentials. Sensitive credentials that require special protection, such as private cryptographic keys, are stored within a private credential set. Credentials intended to be shared, such as public key certificates or Kerberos server tickets are stored within a public credential set.
Constraint: A minimum set of requirements (eg Integrity, Client Authentication, Encryption, Confidentiality, Minimum/Maximum Principals, Server Authentication, Delegation)
Invocation Constraints: Something required or preferred to be satisfied for method invocations to occur. Examples include constraints on integrity, confidentiality, authentication, principals involved in the invocation.
Exporter: Used for exporting a single remote object such that it can receive remote method invocations.
Proxy Preparer: Performs operations on a newly unmarshalled remote proxy to prepare it for use. Typical operations include verifying trust in a proxy, specifying constraints, and granting the proxy permissions.
Group: A collection of principals (represented in Maji as a Category Meem) that is also a principal.
Access Control System: Access control is maintained by facets containing a list of principals it can and cannot communicate with.
Revocation List: A list of security tokens that have been revoked and are no longer valid.
Leasing: A distributed systems technique whereby permissions are revoked after a specified amount of time/use.
Exporters: Abstractions for exporting remote objects and obtaining the server-side context information for an executing remote call.
Snap Frozen Meem: A Meem definition, plus the Meem content. Can be used to reconstruct an operational useable Meem, and used to identify the Meem.
Security Token: A security token can be represented as certificate or a shared secret with a mechanism for presenting that information (this is known as a complete security token). Or a security token can be just the mechanism for generating a shared secret (known as an incomplete security token). A complete security token is sufficient in itself. In contrast, an incomplete security token requires additional information that is processed by the mechanism. For example, a password based encryption key generator.

Generally speaking, there are eight main procedures that the security Feature according to the preferred embodiment carries out. The following describes the eight procedures. It is noted that not all of these procedures need to be carried. The sequences may occur, for example, simultaneously or sequentially.

1. Establishment

The following steps are initially performed by a user of the platform. The first four steps are essentially concerned with establishing an identity for a user of the platform, whilst the last step is concerned with specifying users authorised to use the platform.
S1. Set up ‘Security Group Category’ that can contain Groups and Principals that will be used for determining who is given access.
S2. Request a security token which is:
   Self signed; or
   Issued by trusted third party (security token authority); and
   Stored into one of the ‘Security Group Categories’.
S3. Propagate your identify to other third parties.
S4. Define the list of users in the system and their access rights. This is done by setting the Principals that can and cannot communicate with the objects.
   2. Signing

It is envisaged that device manufacturers can incorporate signatures that are generated at the point of manufacture. This provides the ability to authenticate that the device was legitimately produced by the manufacturer. The signature is incorporated in a security token that can be supplied by trusted third parties.

With reference to FIG. 10, the following five steps are performed by the manufacturer of the device during the signing procedure.
S1. A snap frozen Meem, which consists of a Meem Definition, and Meem Content, the security token uniquely describes the device—is placed into a MeemStore MS1 at the point of manufacture.
S2. The LifeCycleManager LCM0 creates a Meem that represents the device 230.
S3. The device proxy is DP0 is registered with the Meem registry MR0.
S4. The manufacturer is provided with an enrolment Meem EM0.
S5. The enrolment Meem EM0 will use the Meem registry MR0 to locate the Meem that represents the device 230 and at this point update the Meem Content with device 230 specific content, such as Manufacturer, Serial Number, Model, Type, Warranty details, etc.

The result of the five steps is that the Meem becomes a Snap Frozen Meem.

3. Device Imprinting

Device imprinting is the procedure followed when placing a Snap Frozen Meem in a device. With reference to FIG. 11, the following steps are involved in the device imprinting procedure:
S1. Discover a device 230 has a ‘Snap Frozen Meem’—static storage on a chip. System detects new device 230 —gets certificate.
S2. Place snap frozen Meem into local storage
S3. LifeCycleManager LCM0 initiates creation Meem that represents the device locally.
S4. Device Proxy DP0 Notifies Imprinting Meem IM0 that the new device 230 has been brought into environment.
S5. Ask device 230 to generate public/private key pair.
S6. Device 230 provides Public/Private key pair to device proxy DP0.
S7. IM0 signs the key pair personally to recognise and creates the security token.
S8. Create new Snap Frozen Meem, which is stored locally.
S9. Imprinting Meem then informs device proxy to save results.
S10. Store Snap Frozen Meem in MeemStorage, and on the device 230.
   4. Use of Device in Own Environment

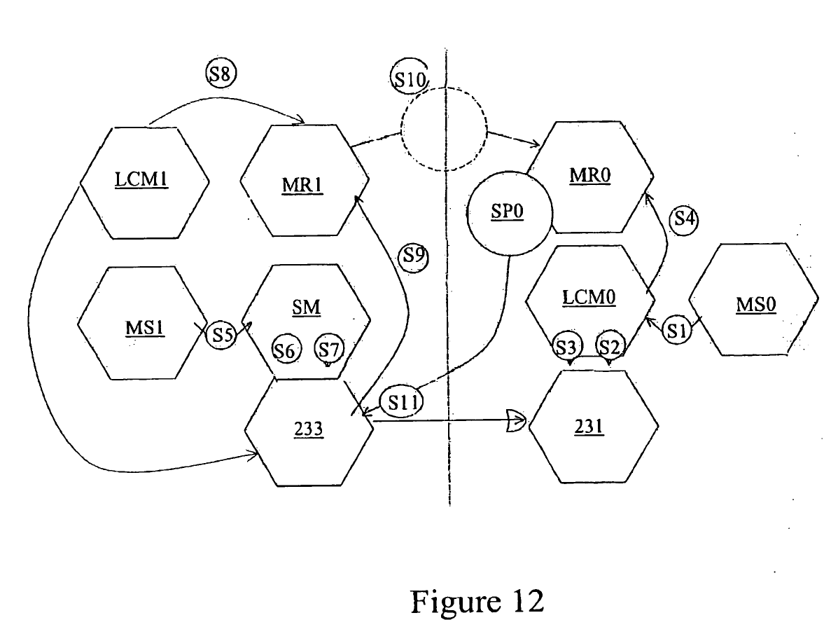

The following steps are carried out when a device (which has a Snap Frozen Meem) operates in its own environment. The sequence of the steps is illustrated in FIG. 12.
S1. Recover the definition and content of the electronic (an example device) lock 231, and load into Lifecycle Manager LCM0.
S2. LifeCycleManager LCM0 assigns device 231, creates software proxy, trusts device 231.
S3. SecurityManager SM signs device 231.
S4. LifeCycleManager LCM0 Registers device 231 with MeemRegistry MR0. A trusted secure proxy SP0 of the device is registered.
S5. Load Snap Frozen Meem.
S6. LifeCycleManager LCM0 creates Meem that represents the device 23B.
S7. Security Manager SM signs device 233.
S8. LifeCycleManager LCM1 Registers with MeemRegistry MR1.
S9. Device 233 attempts to locate lock 231 via MeemRegistry MR1.
S10. MeemRegistry MR1 uses Jini Look-up service to locate trusted proxy SP0 of the device 231.
S11. The device 233 receives the trusted proxy SP0, and established dependency to unlock device 231.
   5. Linking Users

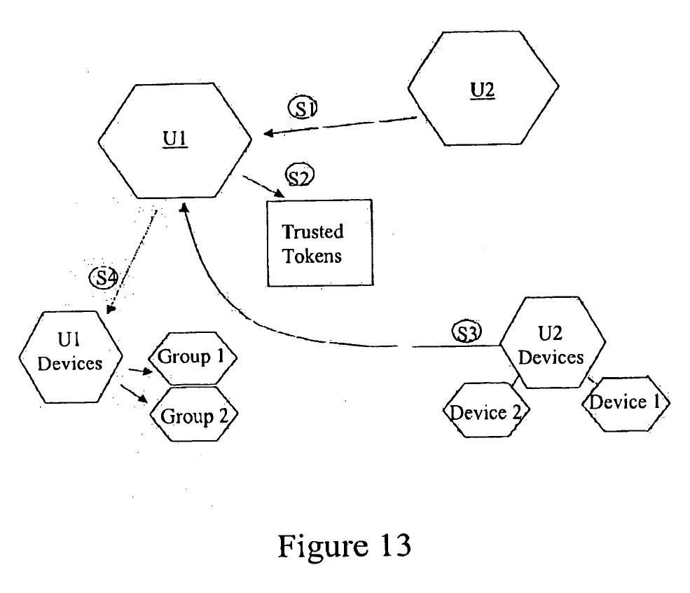

The following procedure is carried out when two users of the platform initially link together. The sequence of the steps is shown in FIG. 13.
S1. User U2 sends user U1 security token.
S2. User U1 decides to trust user U2's security token.
   is it a valid security token?
   within expiry date? signed by a trusted 3^{rd} party?
   not in a revocation list?
S3. User U2 sends Category of devices to user U1.
S4. User U1 puts user U2 and their devices in appropriate Security Group Categories.
S5. Establishing encryption/decryption mechanisms for use in providing secure communication link.

Because U2's devices are enrolled by U2 and U2 is authenticated, U2's devices are now authenticated and given appropriate access.

6. Cooperation Outside Environment

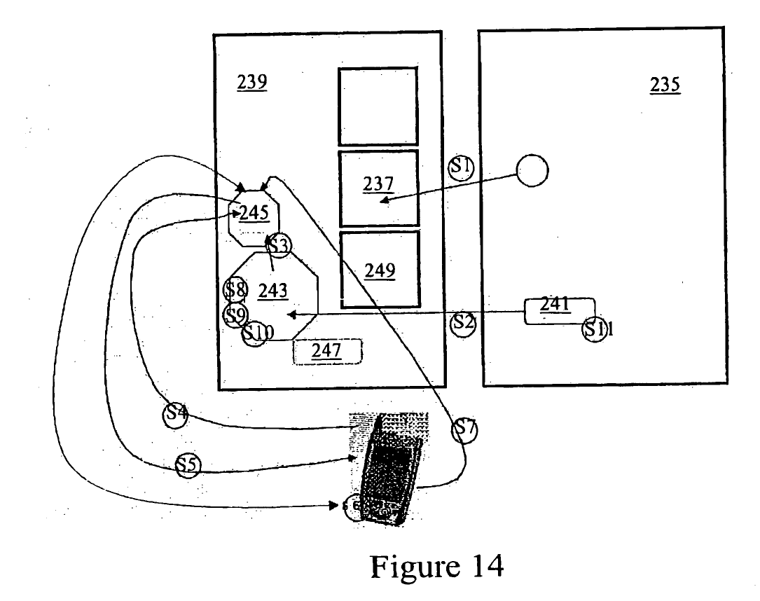

The following steps are performed when two devices attempt to cooperate. The sequence of the steps is shown in FIG. 14. It is assumed that the various steps associated with establishment, signing and imprinting procedures have been performed.
S1. Home Servers 235 (which incorporates a Java Virtual Machine) security token is placed in workplace trusted security tokens record 237 of the work server 239. Optionally, a copy of the my Devices record 241 is created for redundancy, and is configured to listen for changes in My Devices.
S2. My Devices category 241 placed into Door Lock devices category 243. Copy of My Devices placed in door lock devices Category 243.
S3. Add Door lock devices 243 to Principals allowed to access door lock interface 245. Added to Door Locks Invocation constraints.
S4. Look up Door Lock (a device) 247.
S5. Get a reference to the Door Lock (Client side & provider side proxies created) 247.
S6. Client & server security tokens are examined:
   Valid security token structure
   whether security token is trusted or issuer is trusted check whether security token has been revoked by
   referring to a record of revoked security tokens 249.
S7. Invoke lock method on lock facet.
S8. Invocation constraints for the Door Lock 247 are checked. Check whether the devices 235 are allowed devices, i.e. whether in door lock devices.
S9. Iterate through members of Door lock devices category 243.
S10. Iterate through my devices. (leased version)
S11. Find the Principal for the device 235.—OK
   7. Redundancy

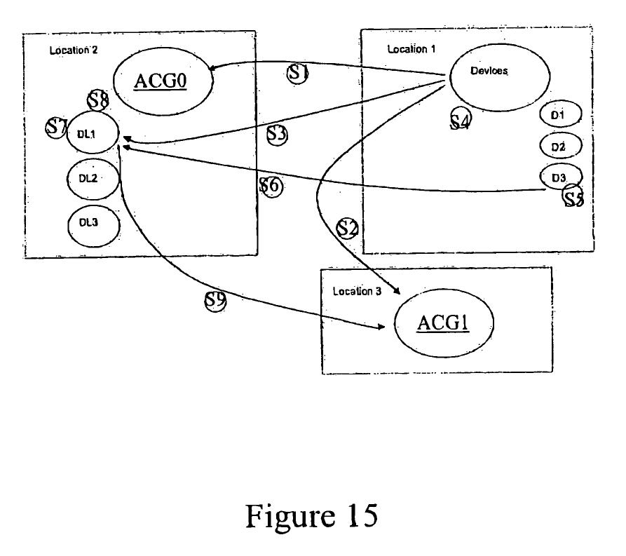

The following steps are performed in order to provide a redundant control list, which is provided as a backup in the event a main control list is unavailable. The steps are described with reference to FIG. 15.
S1. Create the category AC Group ACG0 in Hyperspace.
S2. Create Redundant AC Group ACG1
S3. Add groups ACG0 and ACG1 to set of allowed Principals AP0 for Door Lock.
S4. Put device Group in groups ACG0 and ACG1.
S5. Add a device D3 to device group
S6. Device D3 accesses lock facet of DL1 D3's security token checked.
S7. Security feature on DL1 check if D3 is in ACG0 or ACG1.
   What if Location 2 ACG0 is lost/unavailable?
S8. Principal ACG0 unattainable.
S9. Continue on to check if D3 is in ACG1
   8. Lost Device

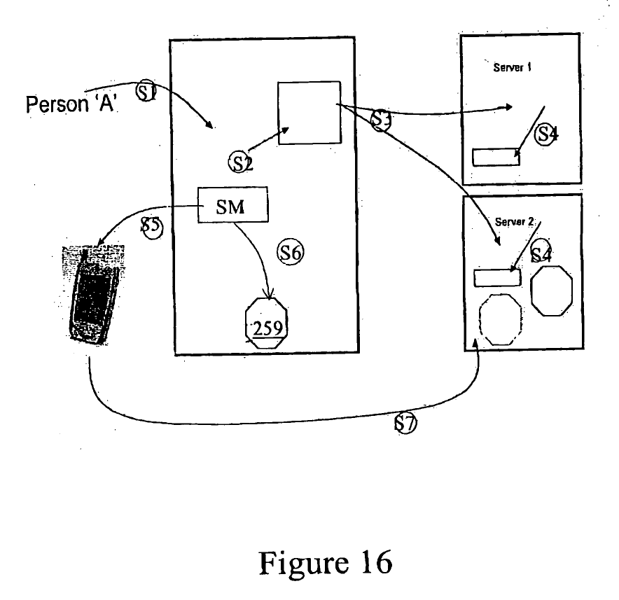

The following steps, which are described with reference to FIG. 16, are carried out when a device is lost.
S1A user (Person A) notifies home server 251 of lost device.
S2. Home server 251 adds lost device's security token to set of revoked security tokens.
S3. Home server 251 broadcasts message to trusted tribe; that is, all other users that have established a trust relationship with the user.
S4. Servers 253 and 255 update their revocation lists thereby removing trust by interested parties in the lost device.
   New Device:
S5. New security token is issued by Home server 251 to the new device 257.
S6. New security token is added to ‘My devices’ group 259.
S7. When the new device 257 connects with another environment that previously established trust with the user the new device 257 is already trusted and access is given.

Those skilled in the art will appreciate that the present invention is susceptible to variations and modifications other than those specifically described. It should be understood that the invention includes all such variations and modifications which fall within the spirit and scope of the invention.

1. A method of providing authorisation for a cooperation between a first object and a second object in a software environment, the method comprising the steps of:
identifying at least one further object that is owned by an owner of the first object, and which has the approval of the owner to engage in the cooperation;
identifying the second object; and
allowing or denying the cooperation based on whether the second object is one of the at least one further object, thereby providing authorisation for the cooperation.

2. The method as claimed in claim 1, wherein the step of identifying the number of objects comprises the step of obtaining a set of one or more identifiers that identify the number of objects.

3. The method as claimed in claim 2, wherein the set of one or more identifiers is one of a plurality of the set.

4. The method as claimed in claim 1, wherein the step of identifying the second object comprises the step of obtaining an identifier of the second object, and determining whether the identifier is a member of the set.

5. The method as claimed in claim 4, wherein the step of obtaining the identifier comprises using a security token to obtain the identifier.

6. The method as claimed in claim 5, wherein the method comprises the step of authenticating the security token to verify the validity of the identifier.

7. The method as claimed in claim 5, wherein the security token comprises an authentication certificate or a shared secret.

8. The method as claimed in claim 7, wherein the authentication certificate is used when there is no trust between the first object and the second object.

9. The method as claimed in claim 7, wherein the shared secret is used when there is trust between the first object and the second object.

10. The method as claimed in claim 5, wherein the method comprises the step of determining whether the security token has been revoked by the owner.

11. The method as claimed in claim 10, wherein the step of determining whether the owner has revoked the security token comprises checking whether the security token is a member of a set of one or more revoked security tokens.

12. The method as claimed in claim 4, wherein the step of allowing or denying the cooperation is also based on the authenticity of the identifier.

13. The method as claimed in claim 5, wherein the preceding claims, wherein the step of allowing or denying the cooperation is further based on whether the security token is contained in the set of one or more revoked security tokens.

14. The method as claimed in claim 1, wherein the method further comprises the step of imposing a constraint on the cooperation.

15. The method as claimed in claim 14, wherein the step of imposing the constraint comprises restricting access to a resource which either the first object or the second object can use.

16. The method as claimed in claim 1, further comprising the step of encrypting/decrypting information exchanged between the first object and the second object.

17. The method as claimed in claim 1, wherein the first object and the second object are each a distributable software object.

18. The method as claimed in claim 1, wherein the cooperation comprises a remote method call.

19. The method as claimed in claim 1, wherein the at least one further object is one of a plurality of further objects.

20. A computer program which, when executed by a computing device, allows the computing device to carry out the method as claimed in claim 1.

21. The computer program as claimed in claim 20, wherein the software comprises a software module arranged to operate as a distributed object.

22. A device operable to carry out the method as claimed in claim 1.

23. A software development platform operable to create the software as claimed in claim 20.

24. A software development framework operable to create the software as claimed in claim 20.
